(19) United States
(12) Patent Application Publication
(10) Pub. No.: US 2015/0316080 A1
(43) Pub. Date: Nov. 5, 2015

(54) FLUID PRESSURE CYLINDER

(71) Applicant: SMC CORPORATION, Chiyoda-ku (JP)

(72) Inventor: Hiroshi KUSAKA, Toride-shi (JP)

(73) Assignee: SMC CORPORATION, Chiyoda-ku (JP)

(21) Appl. No.: 14/677,211

(22) Filed: Apr. 2, 2015

(30) Foreign Application Priority Data
May 2, 2014 (JP) 2014-095058

(51) Int. Cl. F15B 15/08

(52) U.S. Cl. CPC F15B 15/08

(57) ABSTRACT

A fluid pressure cylinder includes a displacement block, which is displaceable on another end side of a body. A second connector of a piston rod that constitutes a cylinder unit is screw-engaged via a second cylinder hole with the displacement block. On the other hand, an end of a suction rod to which a negative pressure fluid is supplied is inserted through a cover member. In addition, by inserting a tool into a tool groove, which is formed on an end of the second connector and rotating the tool in a predetermined direction, the displacement block can be moved with respect to the piston rod in directions to approach and separate away from the body. Stated otherwise, a relative position of the displacement block with respect to the body can be adjusted.

### CROSS-REFERENCE TO RELATED APPLICATION

This application is based upon and claims the benefit of priority from Japanese Patent Application No. 2014-095058 filed on May 2, 2014, the contents of which are incorporated herein by reference.

### BACKGROUND OF THE INVENTION

1. Field of the Invention

The present invention relates to a fluid pressure cylinder in which a piston is displaced along an axial direction under the supply of a pressure fluid.

2. Description of the Related Art

Heretofore, as a member for transporting workpieces, for example, a fluid pressure cylinder has been used having a piston that is displaced under the supply of a pressure fluid. With such a fluid pressure cylinder, for example, a plate is disposed on the end of a piston rod, which is connected to a piston, and a suction pad, which is capable of attracting a workpiece, is installed on the plate. In addition, the piston is displaced by the pressure fluid that is supplied to the fluid pressure cylinder, whereby the plate moves toward the side of the workpiece, and by coming into abutment against the workpiece, the workpiece is attracted by suction to the suction pad.

### SUMMARY OF THE INVENTION

When the aforementioned fluid pressure cylinder is installed on a transport line and transportation of workpieces is carried out, there is a need for adjusting the mounting position of the fluid pressure cylinder or the stroke amount of the piston corresponding to the height of the workpieces, and the procedure for implementing such an adjustment operation tends to be quite complicated.

A general object of the present invention is to provide a fluid pressure cylinder in which positional adjustment of a displacement block along an axial direction with respect to a body can easily and reliably be carried out.

A fluid pressure cylinder according to the present invention includes:

a body including a cylinder chamber in interior thereof to which a driving fluid is supplied;

a cylinder unit including a piston disposed in the body and which is displaceable in the cylinder chamber, and a piston rod connected to the piston;

a supply rod disposed displaceably and substantially in parallel with the piston rod in the body, and including a flow path to which a workpiece retaining fluid is supplied to interior thereof, with a retaining member being installed on a distal end of the supply rod, the retaining member being configured to retain a workpiece and to communicate with the flow path;

a displacement block connected respectively to ends of the supply rod and the piston rod, and which is displaced under a displacement action of the piston; and

a position adjustment member that is configured to adjust a relative position of the displacement block with respect to the body,

wherein the position adjustment member is disposed on the end of the piston rod.

According to the present invention, in the body that makes up the fluid pressure cylinder, the piston and the piston rod of the cylinder unit are disposed for displacement along the cylinder chamber, whereas the supply rod to which the workpiece retaining fluid is supplied is disposed substantially in parallel with the piston rod for displacement. The relative position of the displacement block, in which ends of the piston rod and the supply rod are disposed, can be adjusted with respect to the body by the position adjusting member.

Consequently, by using the position adjusting member to move the displacement block along the axial direction, for example, when the fluid pressure cylinder is installed on a transport line or the like and workpieces are transported by the retaining member that is provided on the displacement block, the position of the displacement block can easily and reliably be adjusted to match with the position of the workpieces.

The above and other objects, features and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is an overall cross sectional view of a fluid pressure cylinder according to an embodiment of the present invention;

FIG. 2 is an enlarged cross sectional view showing a vicinity of a cylinder unit in the fluid pressure cylinder of FIG. 1;

FIG. 3 is an enlarged cross sectional view showing a vicinity of a displacement block in the fluid pressure cylinder of FIG. 1; and

FIG. 4 is a cross sectional view with partial omission showing a condition in which the displacement block in the fluid pressure cylinder of FIG. 1 is moved in a direction to separate away from the body.

### DESCRIPTION OF THE PREFERRED EMBODIMENTS

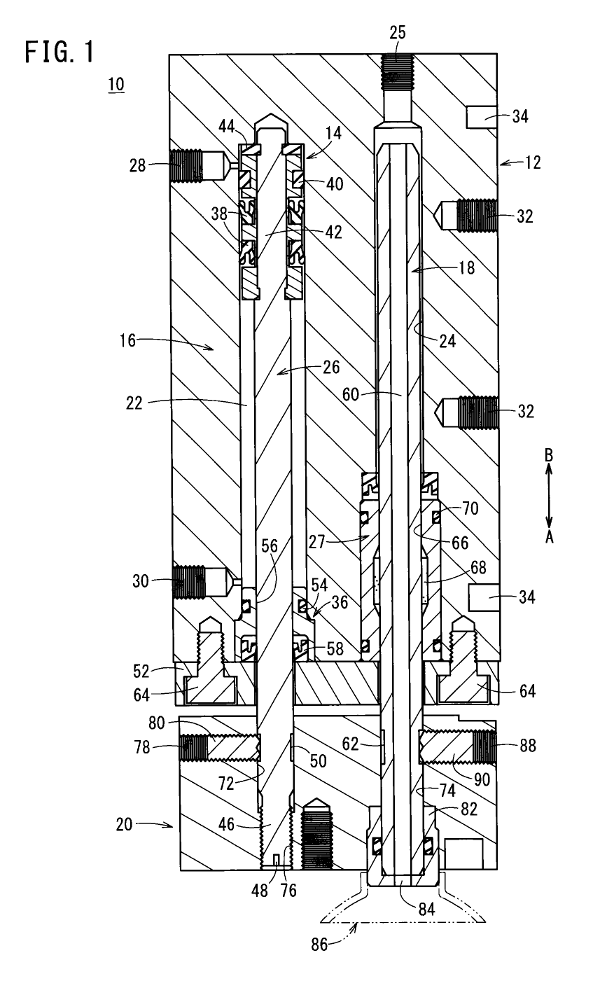

As shown in FIG. 1, a fluid pressure cylinder 10 according to the present invention includes a body 12, a cylinder unit 16 including a piston 14 disposed displaceably along an axial direction (the directions of arrows A and B) of the body 12, a suction rod (supply rod) 18 disposed substantially in parallel with the piston 14, and a displacement block 20, which is connected to the cylinder unit 16 and the suction rod 18, and is disposed so as to be capable of moving to approach and separate away from the body 12. A case will be described in which the displacement block 20 is used in a downwardly located orientation (in the direction of the arrow A) on the fluid pressure cylinder 10.

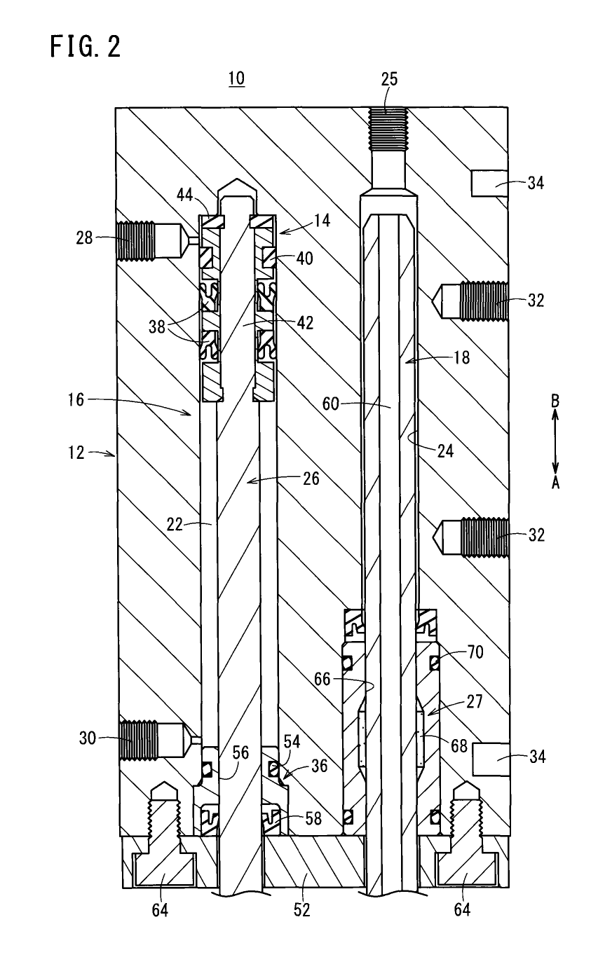

As shown in FIGS. 1 and 2, the body 12 is formed with a substantially rectangular shape in cross section, and for example, made from a metal material. A first cylinder hole 22 and a first rod hole 24 are formed in the interior of the body 12 and extend in the body 12 in the axial direction (the directions of arrows A and B). The first cylinder hole 22 and the first rod hole 24 are separated by a predetermined distance and are formed substantially in parallel. In addition, the first cylinder hole 22 opens on the other end of the body 12. On the other hand, the first rod hole 24 penetrates from one end to the other end of the body 12, and a negative pressure supply port 25, to which a negative pressure fluid is supplied, is formed in the one end of the first rod hole 24.

In addition, the piston 14 and a piston rod 26 that make up the cylinder unit 16 are disposed displaceably in the first cylinder hole 22. On the other hand, the suction rod 18 is inserted through the first rod hole 24, such that the suction rod 18 is supported displaceably in the axial direction (the directions of arrows A and B) by a bearing 27, which is disposed in the vicinity of the other end portion thereof.

First and second ports 28, 30 through which a pressure fluid (driving fluid) is supplied to the first cylinder hole 22 are formed in one side surface of the body 12 adjacent to the first cylinder hole 22. The first port 28 communicates with one end of the first cylinder hole 22, and the second port 30 is connected to and communicates in the vicinity of the other end of the first cylinder hole 22.

Additionally, a non-illustrated pressure fluid supply source is connected via some tubes respectively to the first and second ports 28, 30, and pressure fluid is supplied selectively to one of the first and second ports 28, 30 under a switching action of a switching member (not shown). Owing thereto, the pressure fluid, which is supplied to the first port 28 or the second port 30, is introduced to the first cylinder hole 22.

On the other hand, in the other side surface of the body 12 adjacent to the first rod hole 24, for example, plural attachment holes 32 and locating holes 34 are formed, which are used when fixing the fluid pressure cylinder 10 to a transport arm or the like.

The cylinder unit 16 is disposed in the interior of the body 12, and includes the piston 14, which is disposed in the first cylinder hole 22, the piston rod 26 connected to the piston 14, and a rod cover 36 that displaceably supports the piston rod 26.

The piston 14 is formed, for example, in a cylindrical shape, with a pair of piston packings 38 and a wear ring 40 being mounted respectively via annular grooves on the outer circumferential surface of the piston 14. In addition, the piston packings 38 and the wear ring 40 are arranged in sliding contact with the inner circumferential surface of the first cylinder hole 22. Further, in the interior of the piston 14, a piston hole is formed that penetrates in the axial direction (the directions of arrows A and B), and in the interior thereof, one end of the piston rod 26 is connected by screw-engagement.

The piston rod 26 is made up from a shaft having a predetermined length in the axial direction (the directions of arrows A and B). A first connector 42, which is formed on one end of the piston rod 26 and is smaller in diameter than a central portion thereof, is connected by screw-engagement in the piston hole of the piston 14. A damper 44 is mounted on a region that projects from the one end of the piston 14. The damper 44, for example, is made from an elastic material such as rubber or the like, which prevents direct contact when the piston 14 is displaced toward the one end side of the first cylinder hole 22 (in the direction of the arrow A) under a displacement action of the piston 14, and further prevents the occurrence of shocks and shock noises upon contact.

Further, a second connector 46 formed on the other end of the piston rod 26 is connected by screw-engagement with the displacement block 20, and is displaced integrally in the axial direction (the directions of arrows A and B) under a displacement action of the piston rod 26. A tool groove 48, with which a tool or the like can be engaged, is formed on an end surface thereof on an end of the second connector 46.

The tool groove 48 is exposed on the other end side (in the direction of the arrow A) of the displacement block 20 through an opening of a second cylinder hole 72. By inserting a non-illustrated tool into the tool groove 48 and rotating the tool, the piston rod 26 can be rotated in a state of threaded engagement with the displacement block 20.

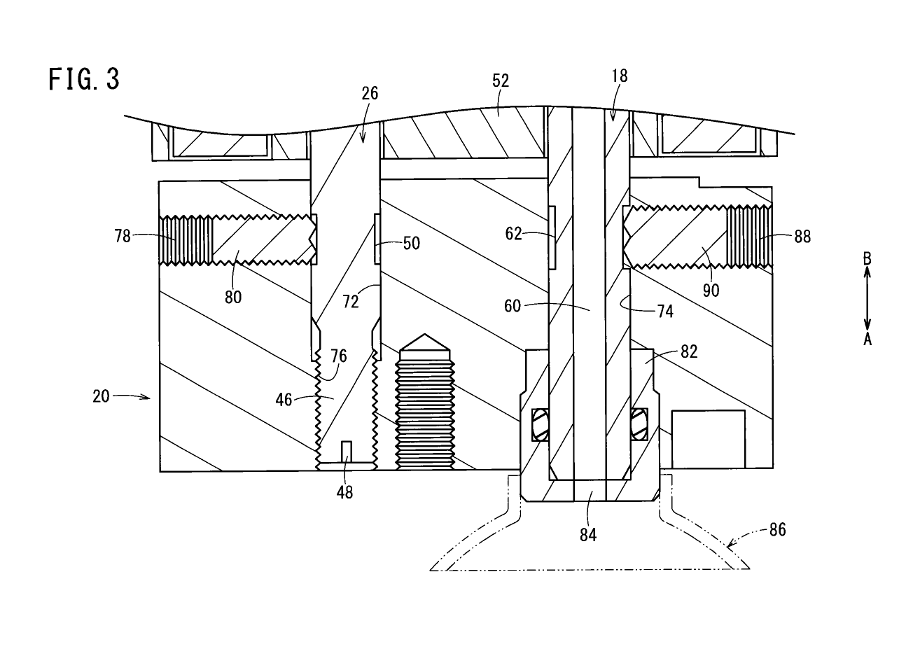

Furthermore, as shown in FIGS. 1 and 3, in the vicinity of the other end of the piston rod 26, a first groove (insertion groove) 50 is formed, which is recessed in an annular shape around the outer circumference of the piston rod 26.

The rod cover 36 is formed in a cylindrical shape, for example, from a metal material, and is inserted from the other end side of the first cylinder hole 22 (in the direction of the arrow B), and is retained by an end plate 52 which is attached to the other end of the body 12. Further, on the outer circumferential surface of the rod cover 36, a sealing ring 54 is disposed through an annular groove, and is placed in abutment against an inner circumferential surface of the first cylinder hole 22. By this feature, leakage of pressure fluid from between the first cylinder hole 22 and the rod cover 36 is prevented.

On the other hand, in the interior of the rod cover 36, a through hole 56 is formed that penetrates therethrough in the axial direction (the directions of arrows A and B). The piston rod 26 is inserted displaceably in the through hole 56, and a rod packing 58, which is mounted on the inner circumferential surface thereof, abuts against the outer circumferential surface of the piston rod 26. Accordingly, leakage of pressure fluid from between the rod cover 36 and the piston rod 26 is prevented by the rod packing 58.

The suction rod 18 is constituted from a shaft having a predetermined length in the axial direction (the directions of arrows A and B), and the suction rod 18 is disposed for displacement along the first rod hole 24. A negative pressure passage (flow path) 60 that penetrates in the axial direction (the directions of arrows A and B) is formed in the center of the suction rod 18. Further, in the vicinity of the other end of the suction rod 18, an annularly recessed second groove 62 is formed along the outer circumferential surface thereof. In the first rod hole 24, a position on the other end side (in the direction of the arrow B) of the body 12 is expanded in diameter, and the cylindrical bearing 27 is provided therein.

The bearing 27 is inserted from the other end side of the first rod hole 24 (in the direction of the arrow B), and is retained in the other end of the body 12 by attachment of the end plate 52. The end plate 52 is formed in a plate-like shape, and is fixed to the end of the body 12 by a plurality of bolts 64.

Further, a guide hole 66 that penetrates in the axial direction (the directions of arrows A and B) is formed, for example, substantially in the center of the bearing 27, and the suction rod 18 is inserted displaceably through the guide hole 66. An annular groove 68, which is recessed in a radially outward direction, is formed in the guide hole 66 in a substantially central portion thereof along the axial direction. A lubricant such as grease or the like fills the annular groove 68. In addition, when the suction rod 18 is displaced along the guide hole 66, by the outer circumferential surface thereof being coated with the lubricant, sliding resistance is reduced, so that the suction rod 18 can be displaced more smoothly.

Furthermore, on the outer circumferential surface of the bearing 27, two (a couple of) O-rings 70 are disposed through annular grooves, and the O-rings 70 are placed in abutment against an inner circumferential surface of the first rod hole 24. Thus, looseness or rattling of the bearing 27 in the first rod hole 24 is prevented.

As shown in FIGS. 1 and 3, the displacement block 20 is formed with, for example, substantially the same widthwise dimension as the body 12. One end and the other end of the displacement block 20 are formed in planar shapes substantially perpendicular to the axes of the piston rod 26 and the suction rod 18.

The displacement block 20 includes the second cylinder hole 72, which is formed coaxially with the first cylinder hole 22 and through which the piston rod 26 is inserted, and a second rod hole 74, which is formed substantially in parallel with the second cylinder hole 72 and through which the suction rod 18 is inserted.

The second cylinder hole 72 includes a threaded portion (screw hole) 76 engraved with threads on the inner circumferential surface thereof, and the second connector 46 of the piston rod 26 is screw-engaged and connected with respect to the threaded portion 76.

Further, on one side surface of the displacement block 20 adjacent to the second cylinder hole 72, a first locking bolt (locking member) 80 is screw-engaged in a screw hole 78 that penetrates through the displacement block 20 up to the second cylinder hole 72. The first locking bolt 80 is disposed so as to be capable of advancing and retracting through the screw hole 78 in a direction substantially perpendicular to the piston rod 26 and the second cylinder hole 72.

In addition, the first locking bolt 80 is screwed and made to move along the screw hole 78 toward the side of the piston rod 26, whereupon the first locking bolt 80 engages with the first groove 50 that is formed in the vicinity of the other end of the piston rod 26. Consequently, movement of the piston rod 26 in the axial direction (the directions of arrows A and B) in the second cylinder hole 72 is restricted, and the piston rod 26 is fixed with respect to the displacement block 20. Stated otherwise, the first locking bolt 80 functions as a fixing member (locking member) for fixing the piston rod 26 with respect to the displacement block 20.

Moreover, the first groove 50 has a width dimension along the axial direction (the directions of arrows A and B) that is somewhat greater than the diameter of the first locking bolt 80 (see FIG. 3).

The second rod hole 74 is formed coaxially with the first rod hole 24 of the body 12. The other end side (in the direction of the arrow A) of the displacement block 20 is expanded in diameter, and a cover member 82, which is U-shaped in cross section, is mounted in the interior thereof. The other end of the suction rod 18 is inserted into the interior of the cover member 82, and a connection port 84 that communicates with the negative pressure passage 60 is formed substantially in the center of the cover member 82. In addition, a suction pad (retaining member) 86 (shown by the two-dot-dashed lines in FIGS. 1 and 3) for grasping a workpiece W, for example, is mounted on the other end of the displacement block 20 through the cover member 82. A negative pressure is supplied through the suction rod 18 to the interior of the suction pad 86.

Further, on another side surface of the displacement block 20 adjacent to the second rod hole 74, a second locking bolt 90 is screw-engaged in a screw hole 88 that penetrates through the displacement block 20 up to the second rod hole 74. The second locking bolt 90 is disposed so as to be capable of advancing and retracting through the screw hole 88 in a direction substantially perpendicular to the suction rod 18 and the second rod hole 74.

In addition, in a state in which the suction rod 18 is inserted through the second rod hole 74, the second locking bolt 90 is screwed and made to move toward the side of the suction rod 18, whereupon the distal end of the second locking bolt 90 is made to engage with the second groove 62 of the suction rod 18. Consequently, movement of the suction rod 18 in the axial direction (the directions of arrows A and B) in the second rod hole 74 is restricted, and the suction rod 18 is fixed with respect to the displacement block 20.

Stated otherwise, the second locking bolt 90 functions as a fixing member for fixing the suction rod 18 with respect to the displacement block 20.

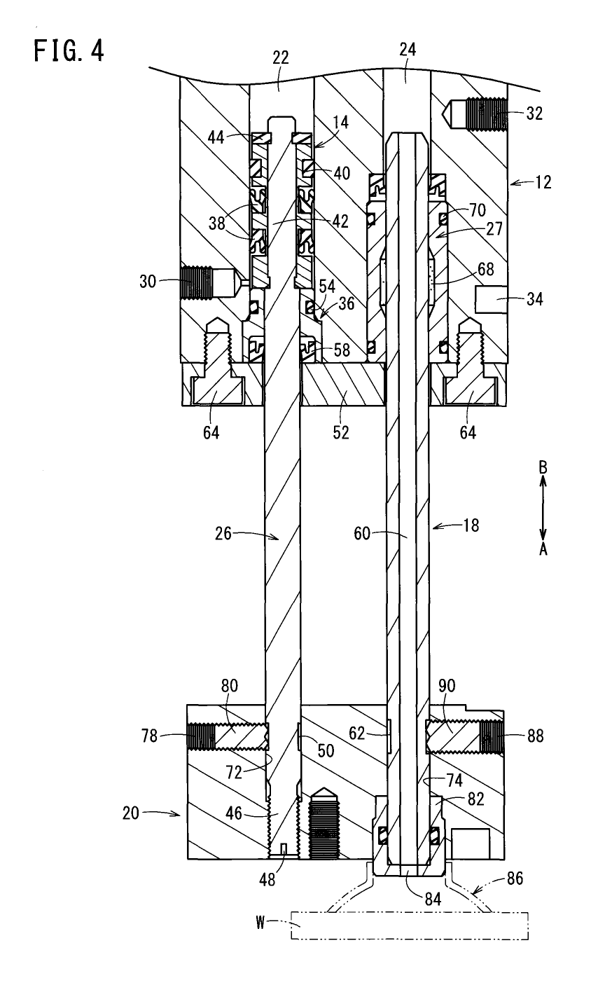

The fluid pressure cylinder 10 according to the embodiment of the present invention is constructed basically as described above. Next, operations and advantages of the present invention will be described. The condition shown in FIG. 1, in which the piston 14 is positioned on the one end side of the body 12 (in the direction of the arrow B), will be treated as an initial position, and together therewith, a case will be described in which a workpiece W (see FIG. 4), which has been placed beneath the suction pad 86 (in the direction of the arrow A), is attracted and transported using the fluid pressure cylinder 10.

First, in the initial position, by supply of pressure fluid to the first port 28 from a non-illustrated pressure fluid supply source, the piston 14 is displaced toward the other end side of the body 12 (in the direction of the arrow A) by the pressure fluid that is introduced to the first cylinder hole 22, accompanied by the piston rod 26 and the displacement block 20 being displaced together integrally. In this case, the second port 30 is placed in a state of being open to atmosphere.

Further, by displacement of the displacement block 20, the suction rod 18, which is connected to the displacement block 20, is displaced integrally therewith in the axial direction (the direction of the arrow A) in a state of being supported by the bearing 27, and the suction pad 86, which is connected to the other end of the suction rod 18, is made to approach the workpiece W (see FIG. 4).

Additionally, as shown in FIG. 4, the piston 14 is displaced further in a downward direction (in the direction of the arrow A), accompanied by the suction pad 86 coming into abutment against the workpiece W. Since a negative pressure fluid is supplied (i.e., vacuum is distributed) from the negative pressure supply port 25, and thereby a negative pressure (vacuum) is applied through the negative pressure passage 60 of the suction rod 18 and the connection port 84 to the interior of the suction pad 86, the workpiece W is attracted to the suction surface of the suction pad 86.

Next, after attraction of the workpiece W has been confirmed, the pressure fluid, which had been supplied to the first port 28, is supplied instead to the second port 30 by operating a non-illustrated switching member. Consequently, the piston 14 is pressed upwardly (in the direction of the arrow B) by the pressure fluid supplied to the first cylinder hole 22, accompanied by the displacement block 20 being raised by way of the piston rod 26 so as to approach toward the side of the body 12. As a result, in a state of being attracted to the suction pad 86, the workpiece W separates upwardly (in the direction of the arrow B) away from the base on which the workpiece W is placed. At this time, accompanying rising of the displacement block 20, the suction rod 18 also is displaced in an upward direction integrally with the displacement block 20.

In addition, in a condition in which the piston 14 is raised to the one end of the first cylinder hole 22, and after having been moved to a predetermined transport position by a transporting device or the like to which the fluid pressure cylinder 10 is fixed, supply of the pressure fluid is switched from the second port 30 to the first port 28. Consequently, the workpiece W is lowered together with the displacement block 20, and in a state in which the workpiece W is placed at a predetermined position, supply of the negative pressure to the negative pressure supply port 25 from the negative pressure supply source is stopped.

As a result, the attracted state of the workpiece W on the suction pad 86 is released, and the transport operation is brought to an end with the workpiece W having been placed at the predetermined position.

Next, a case will be described in which, after the fluid pressure cylinder 10 has been placed in facing relation to the transport line, the position of the displacement block 20 is adjusted to correspond with the position of the workpiece W. In this situation, a condition is established beforehand in which the pressure fluid is not supplied with respect to the first and second ports 28, 30, and a negative pressure fluid is not supplied to the negative pressure supply port 25.

At first, a non-illustrated operator rotates the first locking bolt 80 that is mounted in the displacement block 20, and the first locking bolt 80 moves in a direction to separate away from the piston rod 26, whereby the locked state of the piston rod 26 with respect to the displacement block 20 is released.

Then, the aforementioned operator inserts the distal end of a non-illustrated tool into the tool groove 48 that is formed in the second connector 46 of the piston rod 26, and by rotating the tool, the piston rod 26 is rotated in a predetermined direction. Consequently, the displacement block 20, with which the second connector 46 of the piston rod 26 is screw-engaged, is moved with respect to the piston rod 26 in directions (the directions of the arrows A and B) to separate away from or approach toward the body 12.

In this manner, by using the tool to rotate the piston rod 26, and by suitably adjusting the direction and amount of rotation (number of turns) thereof, the relative positional relationship in the axial direction of the displacement block 20 with respect to the body 12 can be adjusted.

More specifically, under a condition in which the piston 14 is displaced toward the other end side (in the direction of the arrow A) of the body 12, the position of the displacement block 20 is adjusted upwardly or downwardly, so that the suction pad 86, which is mounted on the displacement block 20, can be brought into abutment against the workpiece W.

Finally, after the position of the displacement block 20 has been adjusted, the first locking bolt 80 is screwed and moved to the side of the piston rod 26, whereby the distal end of the first locking bolt 80 is inserted into the first groove 50 in engagement therewith. Consequently, movement of the piston rod 26 in the axial directions (the directions of arrows A and B) with respect to the displacement block 20 is restricted, and the positionally adjusted state is maintained. Stated otherwise, the positionally adjusted condition of the displacement block 20 is maintained.

In the foregoing manner, according to the present embodiment, in the fluid pressure cylinder 10, there is included the displacement block 20 that is disposed on the other end of the body 12 and to which the suction pad 86 is attached. The second connector 46 of the piston rod 26 that makes up the cylinder unit 16 is screw-engaged with the displacement block 20, and the suction rod 18 that communicates with the suction pad 86 is inserted through the displacement block 20.

In addition, by rotation of the piston rod 26 with respect to the displacement block 20, under threaded engagement between the second connector 46 and the second cylinder hole 72, the displacement block 20 can be moved in directions (the directions of arrows A and B) to approach and separate away from the body 12. More specifically, by rotating the piston rod 26 a certain number of times in a desired direction of rotation, the position of the displacement block 20 can easily and reliably be adjusted, so that the suction pad 86, which is disposed on the displacement block 20, can be placed in a position that enables the workpiece W to be attracted thereto under suction.

Further, since the piston rod 26 that makes up the cylinder unit 16 can be used to perform the positional adjustment, for example, in the event that the fluid pressure cylinder 10 is installed on a transport line or the like, and an adjustment operation is carried out after tubes and the suction pad 86 have been mounted, advantageously, there is no need for rotating the side of the suction rod 18 on which the suction pad 86 is mounted.

Furthermore, after the position of the displacement block 20 has been adjusted, by causing the first locking bolt 80 to engage with the first groove 50 of the piston rod 26, relative movement of the positionally adjusted displacement block 20 with respect to the piston rod 26 can reliably be restricted, and the positionally adjusted state of the displacement block 20 can reliably be maintained.

The fluid pressure cylinder according to the present invention is not limited to the embodiment described above. It is a matter of course that various alternative or additional structures may be adopted therein without departing from the scope of the invention as set forth in the appended claims.

What is claimed is:

1. A fluid pressure cylinder comprising:
a body including a cylinder chamber in interior thereof to which a driving fluid is supplied;
a cylinder unit including a piston disposed in the body and which is displaceable in the cylinder chamber, and a piston rod connected to the piston;
a supply rod disposed displaceably and substantially in parallel with the piston rod in the body, and including a flow path to which a workpiece retaining fluid is supplied to interior thereof, with a retaining member being installed on a distal end of the supply rod, the retaining member being configured to retain a workpiece and to communicate with the flow path;
a displacement block connected respectively to ends of the supply rod and the piston rod, and which is displaced under a displacement action of the piston; and
a position adjustment mechanism that is configured to adjust a relative position of the displacement block with respect to the body,
wherein the position adjustment mechanism is disposed on the end of the piston rod.

2. The fluid pressure cylinder according to claim 1, the position adjustment mechanism further comprising:
a threaded portion disposed on the piston rod; and
a screw hole disposed in the displacement block and in which the threaded portion is screw-engaged.

3. The fluid pressure cylinder according to claim 2, wherein the end of the piston rod is exposed to exterior through the screw hole, and a tool groove, in which a tool configured to rotate the piston rod is inserted, is formed in the end of the piston rod.

4. The fluid pressure cylinder according to claim 1, wherein a locking mechanism configured to regulate displacement along an axial direction of the piston rod is disposed on the displacement block.

5. The fluid pressure cylinder according to claim 4, wherein the locking mechanism comprises a locking bolt, which is screw-engaged for advancement and retraction in a direction perpendicular to a direction of extension of the piston rod, and is configured to engage with an outer circumferential surface of the piston rod.

6. The fluid pressure cylinder according to claim 1, wherein the retaining member comprises a suction pad made from a resilient material and formed with a curved shape in cross section.
